(19) United States
(12) Patent Application Publication
(10) Pub. No.: US 2017/0293367 A1
(43) Pub. Date: Oct. 12, 2017

(54) DISPLAY DEVICE, DISPLAY METHOD, AND DISPLAY PROGRAM

(71) Applicant: NEC Corporation, Tokyo (JP)

(72) Inventor: Yoshikazu ARAI, Tokyo (JP)

(21) Appl. No.: 15/511,836

(22) PCT Filed: Sep. 11, 2015
(86) PCT No.: PCT/JP2015/075859

§ 371 Date: Mar. 16, 2017

(30) Foreign Application Priority Data
Sep. 19, 2014 (JP) 2014-191826

(51) Int. Cl. G06F 3/0338; G06F 1/16; G06F 3/038

(52) U.S. Cl. CPC G06F 3/0338; G06F 3/0383; G06F 1/1652

(57) ABSTRACT

A display device includes: a display unit that displays a screen; a plurality of detection sensors that integrally deform with the display unit and output a signal corresponding to the deformation; and a control unit that converts coordinate data on the display unit based on detection data related to the deformation detected by the plurality of detection sensors. Typically, the control unit, based on detection data from the plurality of detection sensors arranged in a plurality of directions, calculates moving direction of a coordinate point on the display unit, and its moving amount and moving speed, the coordinate point corresponding to arrangement directions of the detection sensors.

### TECHNICAL FIELD

The present invention relates to a display device, a display method, and a display program in which a user can operate a display screen by operating a display unit.

### BACKGROUND ART

Elastically deformable flexible display devices are widely being used. These display devices are for example being adopted in various electronic devices that use electronic paper utilizing the electrophoresis phenomenon and organic EL displays as information display means or input means.

For example, in the display device disclosed in Patent Document 1, a part or the whole of the case thereof has flexibility, and is constituted by including a detection unit that detects a portion of the display unit that is being bent, and a display switching unit that switches the display content of the display unit in accordance with the location and bending degree of the portion of the display unit being bent that was detected by the detection unit.

### PRIOR ART DOCUMENTS

### Patent Documents

[Patent Document 1] Japanese Unexamined Patent Application, First Publication No. 2010-157060

### SUMMARY OF THE INVENTION

### Problem to be Solved by the Invention

As stated above, the display device disclosed in Patent Document 1 switches the display content of the display unit in accordance with the location and bending degree of the portion of the display unit being bent that was detected by the detection unit.

Specifically, the display switching unit has functions of:

(i) switching the display content to zoom-in control when the entire display unit is determined to have been bent in a concave shape,

(ii) switching the display content to zoom-out control when the entire display unit is determined to have been be bent in a convex shape, and

(iii) switching a portion of the display content of the display unit when an edge portion of the display unit is determined to be bent.

The detection unit of this kind of display device is merely used as a switch that performs a predetermined ON/OFF operation, with use of the detection unit to perform a pointer operation on the display screen not being possible.

For this reason, when for example causing the pointer to move to a given position on the screen, in addition to requiring direct operation on the ouch panel by the user, a separate input tool such as a cursor button, a mouse or the like is required, leading to operational inconvenience.

The present invention has been achieved in view of the above circumstances, and has as its object to provide a display device in which by operating the display device itself it is possible to operate the display screen, without requiring a direct operation on the touch panel or a separate input tool such as a cursor button, a mouse or the like, and a display method and a display program.

### Means for Solving the Problem

In order to solve the aforementioned issue, the present invention provides a display device that includes: a display unit that displays a screen; a plurality of detection sensors that integrally deform with the display unit and output a signal corresponding to the deformation; and a control unit that converts coordinate data on the display unit based on detection data related to the deformation detected by the plurality of detection sensors.

The present invention also provides a display method that includes the steps of: taking in detection data from a plurality of detection sensors, the detecting sensors integrally deforming with a display unit and outputting a signal corresponding to the deformation; and converting coordinate data on the display unit based on the detection data taken in from the plurality of detection sensors.

The present invention also provides a display program that includes: taking in detection data from a plurality of detection sensors, the detecting sensors integrally deforming with a display unit and outputting a signal corresponding to the deformation; and converting coordinate data on the display unit based on the detection data taken in from the plurality of detection sensors.

### Effect of the Invention

According to the present invention, it is possible to operate a display screen by an operation that deforms a display unit itself.

### BRIEF DESCRIPTION OF THE DRAWINGS

FIG. 1 is a plan view that shows a display unit according to the present invention.

FIG. 2 is a plan view of a display device according to a first exemplary embodiment.

FIG. 3 is a view that shows a control pattern of the display device according to the first exemplary embodiment.

FIG. 4 is a flowchart that shows a control content relating to a control unit of the first exemplary embodiment.

FIG. 5A is a view that shows a use example of the display device according to the first exemplary embodiment, being a view that shows the case of undergoing a curving operation.

FIG. 5B is a view that shows a use example of the display device according to the first exemplary embodiment, being a view that shows an example of an image of the display device being displayed on a large-screen monitor.

FIG. 6A is a view that shows a detection sensor arrangement pattern of a display device according to the second exemplary embodiment, being an example that shows a modified pattern of FIG. 2.

FIG. 6B is a view that similarly shows a detection sensor arrangement pattern of the display device according to the second exemplary embodiment, being an example in which two detection sensors along the vertical direction are added in the central portion.

FIG. 6C is a view that similarly shows a detection sensor arrangement pattern of the display device according to the second exemplary embodiment, being an example in which two detection sensors along the horizontal direction are added in the central portion.

FIG. 6D is a view that similarly shows a detection sensor arrangement pattern of the display device according to the second exemplary embodiment, being an example in which detection sensors arc provided concentrated at a corner portion.

### EXEMPLARY EMBODIMENTS FOR CARRYING OUT THE INVENTION

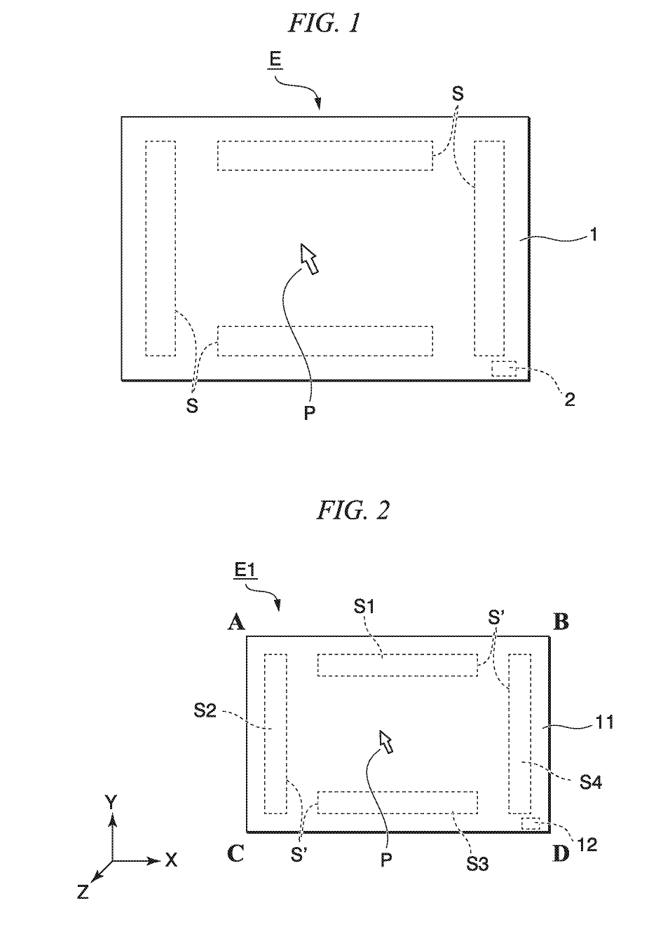

FIG. 1 is a view that shows a minimum configuration of a display device E according to the present invention.

This display device E includes a plurality of detection sensors S that integrally deform with a display unit 1 and output signals corresponding to the deformation, and a control unit 2 that converts coordinate data on the display unit 1 on the basis of deformation-related detection data detected by the plurality of detection sensors S.

The display unit 1 serves as a display of the display device E, and is formed with an elastically deformable sheet-shaped member.

Detection sensors S integrally deform with the display unit 1 and output a signal corresponding to the deformation, and are installed in different directions on the rear surface of the display unit 1 (at least one per one direction).

On the basis of detection values by the plurality of detection sensors S arranged in multiple directions, the control unit 2 calculates, for example, the moving direction of a pointer P on the display unit 1 corresponding to an arrangement directions of the detection sensors S as well as the moving amount and moving speed, and on the basis of the calculation result performs coordinate conversion of the pointer P on the display unit 1.

As described above, according to the display device E, a plurality of detection sensors S that output detection signals corresponding to the deformation of the display unit 1 are provided, and the control unit 2 performs coordinate conversion of the pointer P on the display unit 1 from deformation-related detection data detected by the plurality of detection sensors S.

Thereby, in the display device E, just by the user deforming the display unit 1, since detection data corresponding to that deformation is output from the plurality of detection sensors S, it is possible to perform coordinate conversion of the pointer P on the display unit 1 from that detection data.

That is, in the display device E of the present invention, it is possible to easily perform an operation on the display screen on the basis of the coordinate data of the pointer P just by deforming the display unit 1, without requiring a direct operation on a touch panel, or a separate input tool such as a cursor button or a mouse in the manner heretofore.

### First Exemplary Embodiment

A display device E1 according to a first exemplary embodiment of the present invention will be described referring to FIG. 2 to FIG. 5B.

FIG. 2 is the display device E1 according to the first exemplary embodiment which includes a plurality of detection sensors S′ that integrally deform with a display unit 11 and output signals corresponding to the deformation, and a control unit 12 that performs coordinate conversion of the pointer P on the display unit 11 from detection data related to the deformation detected by the plurality of detection sensors S′.

The display unit 11 serves as a display of the display device E1, and is constituted with a sheet-shaped member having elastically deformable flexibility.

The detection sensors S′ includes strain sensors S1 to S4 that integrally deform with the display unit 11 and output detection signals corresponding to the deformation, and are arranged in different directions (the X and Y directions in the present example) on the rear surface of the display unit 11.

Specifically, as shown in FIG. 2, the strain sensor S1 is arranged so as to follow the upper edge portion of the display unit 11, the strain sensor S2 is arranged so as to follow the left edge portion of the display unit 11, the strain sensor S3 is arranged so as to follow the lower edge portion of the display unit 11, and the strain sensor S4 is arranged so as to follow the right edge portion of the display unit 11.

On the basis of the detection values of the detection sensors S1 to S4 arranged in the plurality of directions, the control unit 12 for example performs coordinate conversion of the pointer P on the display unit 11 corresponding to the arrangement directions of the detection sensors S′, and displays the position of the pointer on the display unit 11 in correspondence with the coordinate data.

Note that in the following description, the case of the display unit 11 being curved and extended to the rear side is indicated by “plus”, and the case of the display unit 11 being curved and contracted to the front side is indicated by “minus”.

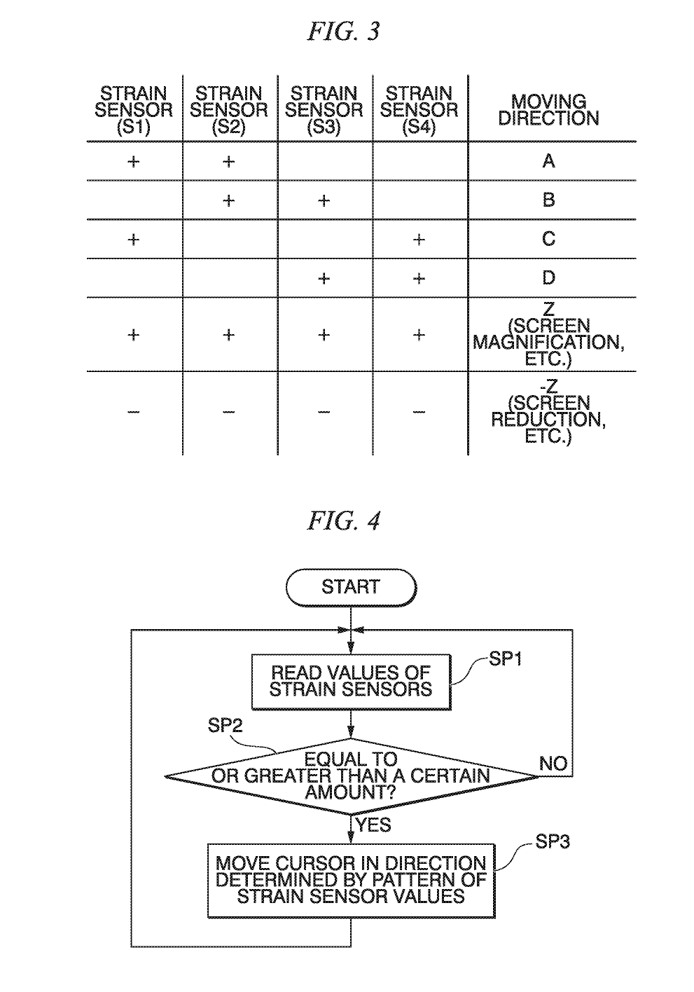

Specifically, as shown in FIG. 3, in the case of the upper-left corner portion of the display unit 11 (indicated by the symbol A) being curved to the rear side (plus side), strain data in the plus direction are output from both the strain sensor S1 that follows the upper edge of the display unit 11 and the strain sensor S2 that follows the left edge of the display unit 11.

Thereby, the control unit 12 recognizes that the upper-left corner portion A of the display unit 11 has been curved to the rear side (plus side). The control unit 12, on the basis of strain data output from the strain sensors S1, S2 at this time, converts the coordinates of the pointer on the display screen of the display unit 11 toward the upper-left corner portion A of the display unit 11 and thereby causes the pointer to move in the same direction.

Note that in the present exemplary embodiment, in accordance with the amount of strain detected, the strain data is converted to coordinate data such that the coordinate change to the + (or −) direction becomes greater as the change increases. In what manner the strain data is converted, such as for example converting the coordinate data in accordance with a change in the strain amount (differential value), is appropriately changed depending on the function of the display device itself and the substance of the contents displayed.

Also, in the case of curving the upper-right corner portion of the display unit 11 (indicated by the symbol B) toward the rear side (plus side), strain data in the plus direction is output from both the strain sensor S1 along the upper edge portion of the display unit 11 and the strain sensor S4 along the right edge of the display unit 11. Thereby, the control unit 12 recognizes that the upper-right corner portion B of the display unit 11 has been curved to the rear side (plus side). The control unit 12, on the basis of strain data output from the strain sensors S1, S4 at this time, converts the coordinates of the pointer on the display screen of the display unit 11 toward the upper-right corner portion B of the display unit 11 and thereby causes the pointer to move in the same direction.

Also, in the case of curving the lower-left corner portion of the display unit 11 (indicated by the symbol C) toward the rear side (plus side), strain data in the plus direction is output from both the strain sensor S2 along the left edge portion of the display unit 11 and the strain sensor S3 along the lower edge of the display unit 11. Thereby, the control unit 12 recognizes that the lower-left corner portion C of the display unit 11 has been curved to the rear side (plus side). The control unit 12, on the basis of strain data output from the strain sensors S2, S3 at this time, converts the coordinates of the pointer on the display screen of the display unit 11 toward the lower-left corner portion C of the display unit 11 and thereby causes the pointer to move in the same direction.

Also, in the case of curving the lower-right corner portion of the display unit 11 (indicated by the symbol D) toward the rear side (plus side), strain data in the plus direction is output from both the strain sensor S3 along the lower edge portion of the display unit 11 and the strain sensor S4 along the right edge of the display unit 11. Thereby, the control unit 12 recognizes that the lower-right corner portion D of the display unit 11 has been curved to the rear side (plus side). The control unit 12, on the basis of strain data output from the strain sensors S3, S4 at this time, converts the coordinates of the pointer on the display screen of the display unit 11 toward the lower-right corner portion D of the display unit 11 and thereby causes the pointer to move in the same direction.

Here, the above-mentioned process is performed when each corner portion is curved to the rear side (plus side). When each corner portion is curved to the front side (minus side), it is made to move in directions opposite to the directions mentioned above (directions A to D) (for example, when the upper-left corner portion of the display unit 11 (shown by the symbol A) is curved to the front side (minus side), the D direction).

Also, when the four corner portions of the display unit 11 (that is, the entire display unit) are curved to the rear side, all the strain sensors S1 to S4 become plus, and thereby the display screen only is magnified without converting the coordinates of the pointer on the display screen of the display unit 11.

Also, when the four corner portions of the display unit 11 (that is, the entire display unit) are curved to the front side, all the strain sensors S1 to S4 become minus, and thereby the display screen only is reduced without converting the coordinates of the pointer on the display screen of the display unit 11.

In the aforementioned coordinate conversion process, threshold values are provided in stages with respect to the detection data of each strain sensor S1 to S4, and the moving amount of the coordinates is calculated according to which threshold value the data has exceeded, and the moving speed of the coordinates is calculated according to which threshold value the data is reached within a preset time.

The process flow relating to the coordinate conversion process mentioned above is described referring to FIG. 4. Note that this process flow is executed by the control unit 12, and is based on a display method and the display program of the present invention.

### (Step SP1)

First, each detection data of the strain sensors S1 to S4 constituting the detection sensors S′ is read, and the process proceeds to the next step SP2.

### (Step SP2)

It is detected whether the strain value at each location shown by the detection data of the strain sensors S1 to S4 exceeds the threshold values provided in stages, and it is detected which threshold value the strain value has reached within an established time set in advance, and then proceeds to Step 3.

Note that in this step SP2, while the strain value of any given location is increasing, by returning to step SP1 each time the threshold value is exceeded to fetch new detection data of the new strain sensors S1 to S4, the next step SP3 is executed on the basis of the ultimate curved state.

### (Step SP3)

After calculating the moving direction of the pointer shown in FIG. 3 as well as the moving amount and moving speed of the pointer on the basis of the detection result in step SP2, the process returns to the previous step SP1.

According to the display device E1 of the first exemplary embodiment described above, the detection sensors S′ are provided which include the plurality of strain sensors S1 to S4 that output detection signals corresponding to the deformation of the display unit 11, and the control unit 12 performs coordinate conversion of the pointer P on the display unit 11 from detection data related to the deformation detected by the plurality of strain sensors S1 to S4.

Thereby, in the display device E1 of the first exemplary embodiment, just by the user deforming the display unit 11, since detection data corresponding to that deformation is output from the plurality of strain sensors S1 to S4, from that detection data is calculated the moving direction of the pointer P on the display unit 11 that corresponds to the arrangement directions of the strain sensors S1 to S4 as well as the moving amount and moving speed, and on the basis of the calculation result coordinate conversion of the pointer P on the display unit 11 is performed.

That is, in the display device E1 of the first exemplary embodiment, a user can easily perform a pointer operation on the display screen on the basis of coordinate data just by deforming the display portion 11, without requiring a direct operation on a touch panel, or a separate input tool such as a cursor button or a mouse in the manner heretofore.

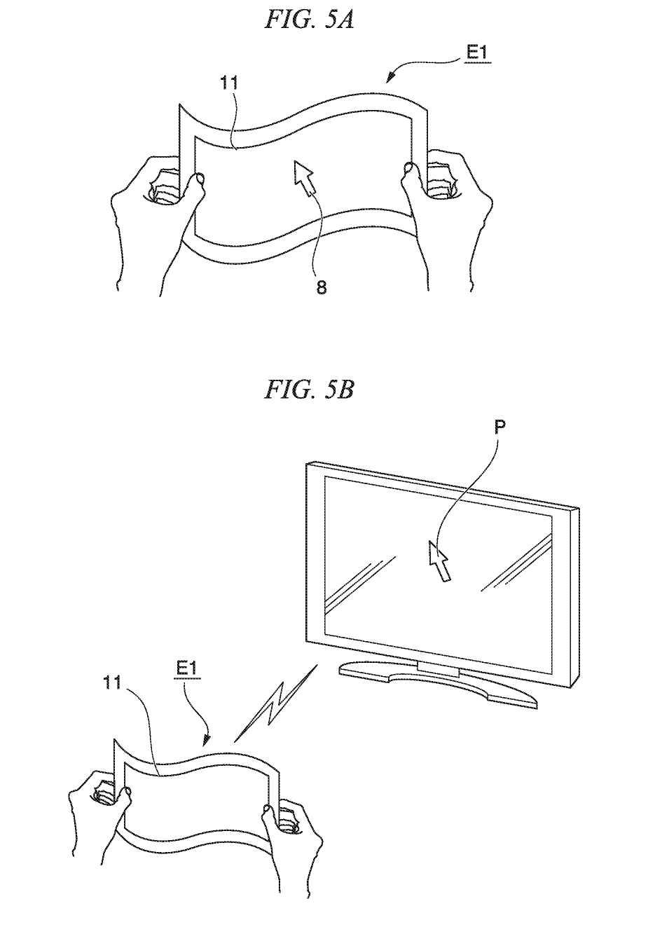

Note that as a specific method of using the display device E1 of the first exemplary embodiment, as shown in FIG. 5A, the user grasps the left and right side edge portions with both hands and curves the display unit 11 in the directions indicated by the arrows A to D and/or in a combination of these directions, thereby converting the coordinate position of the pointer.

Also, in addition to this, as shown in FIG. 5B, there may be a configuration that transfers data relating to the coordinate position of the pointer, along with the image to be displayed in the display unit 11, to a large-size image device such as a monitor, such that the display image and the pointer image in the display unit 11 are viewed in the image device.

### Second Exemplary Embodiment

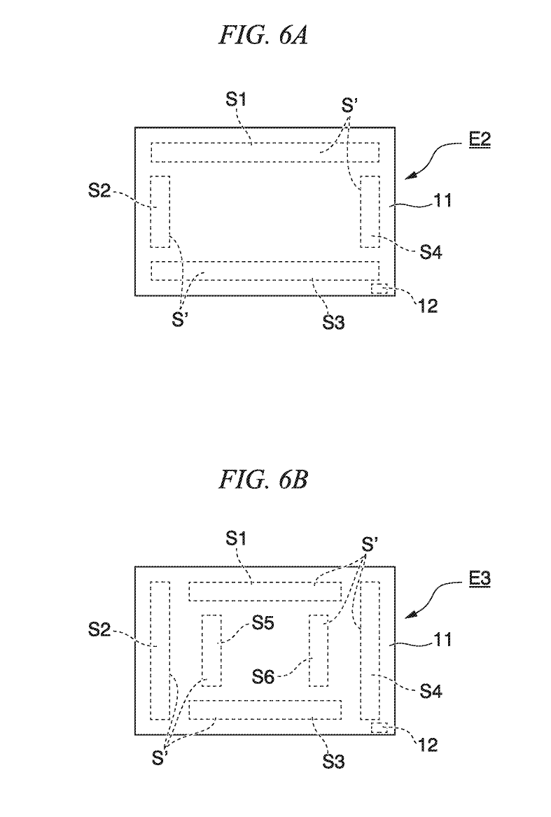

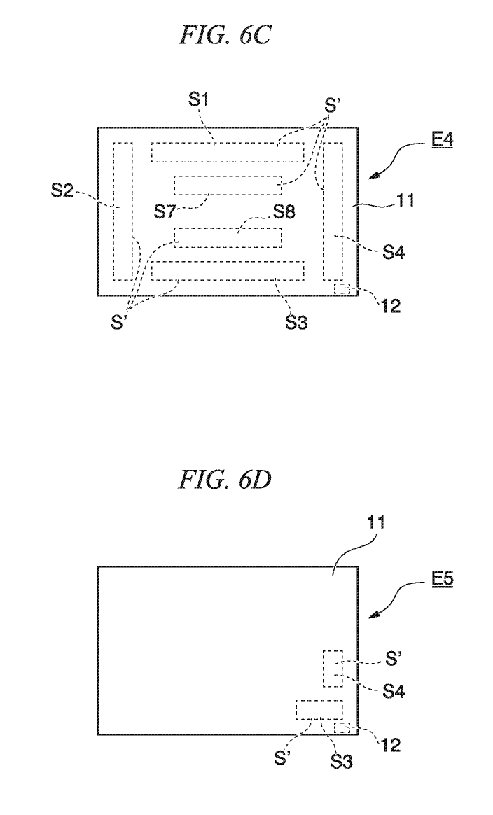

Display devices E2 to E4 according to a second exemplary embodiment of the present invention will be described referring to FIGS. 6A to 6D.

The display devices E2 to E4 shown in these figures differ from the display device E1 shown in the first exemplary embodiment in the arrangement pattern of the strain sensors, which serve as the detection sensors S′.

As described above, the detection sensors S′ are installed in a plurality in different directions (X and Y directions in this example) on the rear surface of the display unit 11 (at least one sensor in one direction). In the present exemplary embodiment, various arrangement patterns are presented.

Specifically, in the display device E1 of the first exemplary embodiment shown in FIG. 2, the strain sensors S1 and S3 are arranged between the strain sensors S2 and S4, but in the display device E2 shown in FIG. 6A of the second exemplary embodiment, the strain sensors S2 and S4 are arranged between the strain sensors S1 and S3.

Also, in the display device E3 shown in FIG. 6B of the second exemplary embodiment, in the interior that is surrounded by the strain sensors S1 to S4, the strain sensors S5 and S6 are additionally arranged in the vertical direction in the figure.

Moreover, in the display device E4 shown in FIG. 6C of the second exemplary embodiment, in the interior that is surrounded by the strain sensors S1 to S4, the strain sensors S7 and S8 are additionally arranged in the horizontal direction in the figure.

Furthermore, in the display device E5 shower in FIG. 6D of the second exemplary embodiment, the strain sensors S3 and S4 are arranged concentrated at only one corner portion at the lower right in the figure, among the four corners. With this constitution, it is possible to deformably operate the display device E5 in the state of one corner portion being held by one hand (the right hand, which is generally the dominant hand). Also, since the region that deforms is limited to one corner portion, the range in which the display screen deforms (goes out of shape) as part of operation can be minimized.

In the display devices E1 to E5 shown in these exemplary embodiments, by installing the strain sensors S1 to S8, which serves as the detection sensors S′, in various arrangement patterns, coordinate conversion of the pointer P in accordance with the use state of the display device becomes possible.

That is, in these display devices E1 to E5, by appropriately selecting the arrangement pattern of the strain sensors S1 to S8 in accordance with the use state, it is possible to accurately calculate the moving direction of the pointer P on the display unit 11 that corresponds to the arrangement directions of the strain sensors S1 to S8 as well as the moving amount and moving speed, and on the basis of the calculation results, it is possible to accurately perform coordinate conversion of the pointer P on the display unit 11.

Also, the parameter that is changed by the display device is not limited to the amount of change in each axial direction of the three-dimensional coordinates, it may be used for control to change speed in the case of changing an image in the time axis direction (moving picture display), or screen luminance, color balance, contrast or the like.

Note that as the dimensions and number of the strain sensors S1 to S8 increase (as the region in which the strain sensors are provided increases), subtle operations and diverse operations become possible, while reducing the dimensions and number of the strain sensors S1 to S8 is also effective for reducing the range of the display screen that deforms with an operation.

Exemplary embodiments of the present invention have been described in detail with reference to the drawings. However, specific configurations are not limited to these exemplary embodiments, and design modifications without departing from the scope of the invention are also included.

This application is based upon and claims the benefit of priority from Japanese patent application No. 2014-191826, filed on Sep. 19, 2014, the disclosure of which is incorporated herein in its entirety by reference.

### INDUSTRIAL APPLICABILITY

The present invention relates to a display device in which a user can freely operate a pointer in the display screen by curving the display unit in a specific direction.

### REFERENCE SYMBOLS

1: Display unit

2: Control unit

11: Display unit

12: Control unit

E: Display device

E1: Display device

E2: Display device

E3: Display device

E4: Display device

S: Detection sensor

S′: Detection sensor

1. A display device comprising:
a display unit that displays a screen;
a plurality of detection sensors that integrally deform with the display unit and output a signal corresponding to the deformation; and
a control unit that converts coordinate data on the display unit based on detection data related to the deformation detected by the plurality of detection sensors.

2. The display device according to claim 1, wherein the control unit, based on detection data from the plurality of detection sensors arranged in a plurality of directions, calculates moving direction of a coordinate point on the display unit, and its moving amount and moving speed, the coordinate point corresponding to arrangement directions of the detection sensors.

3. The display device according to claim 1, wherein the control unit, based on detection data from the detection sensors, increases a moving amount of a coordinate point in a predetermined direction the greater the deformation of the display unit, the predetermined direction corresponding to an arrangement direction of the detection sensors.

4. The display device according to claim 1, wherein the control unit, based on detection data from the detection sensors, increases a moving speed of a coordinate point in a predetermined direction the greater a bending speed of the display unit, the predetermined direction corresponding to an arrangement direction of the detection sensors.

5. The display device according to claim 1, wherein the detection sensors are arranged such that strain detection directions of the display unit are different from each other.

6. The display device according to claim 1, wherein each of the detection sensors is arranged along an edge portion of the display unit.

7. The display device according to claim 1, wherein the detection sensors are arranged concentrated at a corner portion of the display unit.

8. The display device according to claim 7, wherein the detection sensors are arranged at one corner portion at a lower portion of the display unit.

9. The display device according to claim 2, wherein the coordinate point corresponds to a pointer on a display screen in the display unit.

10. The display device according to claim 1, wherein the display unit is constituted with a sheet-shaped member having flexibility.

11. A display method comprising the steps of:
taking in detection data from a plurality of detection sensors, the detecting sensors integrally deforming with a display unit and outputting a signal corresponding to the deformation; and
converting coordinate data on the display unit based on the detection data taken in from the plurality of detection sensors.

12. A non-transitory computer-readable recording medium storing a display program, the display program causing a computer to execute:
taking in detection data from a plurality of detection sensors, the detecting sensors integrally deforming with a display unit and outputting a signal corresponding to the deformation; and
converting coordinate data on the display unit based on the detection data taken in from the plurality of detection sensors.
